(19) United States
(12) Patent Application Publication
(10) Pub. No.: US 2025/0224371 A1
(43) Pub. Date: Jul. 10, 2025

(54) METHOD OF DETERMINING THE ENANTIOMERIC PURITY OF AN ANALYTE

(71) Applicant: Micromass UK Limited, Wilmslow, Cheshire (GB)

(72) Inventor: Dale Cooper-Shepherd, Marple (GB)

(73) Assignee: Micromass UK Limited, Wilmslow, Cheshire (GB)

(21) Appl. No.: 18/848,025

(22) PCT Filed: Mar. 16, 2023
(86) PCT No.: PCT/GB2023/050643

§ 371 Date: Sep. 17, 2024

(30) Foreign Application Priority Data
Mar. 17, 2022 (GB) 2203746.9

(51) Int. Cl. G01N 27/623; H01J 49/00; H01J 49/26

(52) U.S. Cl. CPC G01N 27/623; H01J 49/0036; H01J 49/26

(57) ABSTRACT

A method of determining the enantiomeric purity of an analyte, comprising: ionising the analyte to form dimer ions; separating ions of different dimers of the analyte by ion mobility; detecting a first ion mobility peak corresponding to ions of one or more first dimers and detecting a second ion mobility peak corresponding to ions of one or more second dimers; and determining the enantiomeric purity of said analyte from the ratio of the peak area of the first ion mobility peak to the peak area of the second ion mobility peak.

### CROSS-REFERENCE TO RELATED APPLICATION

This application claims priority from and the benefit of United Kingdom patent application No. 2203746.9, which was filed on 17 Mar. 2022. The entire content of this application is incorporated herein by reference.

### FIELD OF THE INVENTION

The present invention relates to a method of determining the enantiomeric purity of an analyte using an analytical instrument such as a mass and/or ion mobility spectrometer. The invention also concerns an instrument configured to carry out such a method.

### BACKGROUND

Determining the enantiomeric purity of compounds is of crucial importance in various areas of chemistry, none more so than in the pharmaceutical industry, where different enantiomers can have vastly different effects on the body.

Any chiral discrimination typically requires a chiral probe. Examples of such probes include circularly polarised light to assess enantiomeric excess in synthesis, chiral catalysts and reagents in chiral-directed (or enantio-selective) synthesis, chiral stationary phases in chiral chromatography, or chiral substrates in chiral NMR.

Ideally it would be possible to distinguish between enantiomers in a relatively quick and easy manner, such as by using an ion mobility separator (IMS) to separate the enantiomers. However, enantiomers cannot be separated by ion mobility alone, no matter the resolution of the IMS device used. This is because enantiomers have the same collisional cross-sections (CCSs) and thus interact with the background gas in the IMS device to the same degree. In theory, some sort of chiral modifier is required for modifying the enantiomers such that they have different mobilities through the IMS device, but this is not yet available on commercial IMS systems.

Previous studies (Anal. Chem. 2006, 78, 8200-8206) have used S-butanol as a chiral dopant in drift tube ion mobility separation to separate D- and L-forms of amino acids. The chiral solvent was added to the background gas of the IMS drift tube and transient analyte-solvent complexes were purported to have different mobilities through the gas and hence enable separation of the D- and L-forms of the amino acids. However, such techniques require further research to become a reliable enantiomeric differentiation technique.

### SUMMARY OF THE INVENTION

In a first aspect, there is provided a method of determining the enantiomeric purity of an analyte, comprising:
ionising the analyte to form dimer ions;
separating ions of different dimers of the analyte by ion mobility;
detecting a first ion mobility peak corresponding to ions of one or more first dimers and detecting a second ion mobility peak corresponding to ions of one or more second dimers; and
determining the enantiomeric purity of said analyte from the ratio of the peak area of the first ion mobility peak to the peak area of the second ion mobility peak.

An ion mobility separator (IMS) is used to perform said step of separating the dimer ions. The one or more first dimers elute from the IMS device at a first time and these ions (or ions derived therefrom) are detected so as to form the first ion mobility peak. Similarly, the one or more second dimers elute from the IMS device at a second, different time and these ions (or ions derived therefrom) are detected so as to form the second ion mobility peak.

The IMS device may comprise an ion guide containing a gas therein and electrodes configured to generate an electric field that drives ions against the gas such that the ions separate according to their mobility through the gas. The ions then elute (i.e. exit) the IMS device at different times depending on their mobility.

The present inventors have surprisingly found that the self-dimerisation of chiral molecules can be used as basis for chiral differentiation in IMS. The dimerization can give different diastereomers, which have different collisional cross-sections and hence different ion mobilities This offers the possibility of facile determination of enantiomeric purity/excesses by IMS without any additional preparatory steps, chiral complexing reagents or chiral gases.

The first ion mobility peak may correspond to homodimer ions and the second ion mobility peak may correspond to heterodimer ions.

The method may comprise determining that the peak area of the second mobility peak is equal to or less than the peak area of the first mobility peak, and consequently that the first mobility peak corresponds to the ion mobility of homodimer ions of said analyte, and the second mobility peak corresponds to heterodimer ions of said analyte.

The first ion mobility peak may correspond to ions of at least two types of different dimers and/or the second ion mobility peak may correspond to ions of at least two types of different dimers. For example, the first ion mobility peak may correspond to ions of the SS dimer and the RR dimer. Additionally, or alternatively, the second ion mobility peak may correspond to ions of the SR dimer and the RS dimer.

Each of the dimers may be formed from gas phase monomer ions that are hydrogen-bonded to each other.

The method may be carried out in the absence of a chiral selector and/or in the absence of a chiral complexing agent. In other words, a chiral selector and/or chiral complexing agent is not used to separate the different dimers of the analyte. Rather, the ions of the different dimers are desirably only separated from each other by driving the ions through a neutral gas (i.e. a gas that does not chemically react with the dimer ions).

The step of separating ions may be performed by an ion mobility separator; wherein ions that elute from the separator, or ions derived therefrom, are detected and mass analysed in a mass analyser so as to obtain mass spectral data that is representative of the mass to charge ratios of the ions that are detected, and wherein the mass spectral data for ions detected at any given time is correlated to the elution time of ions from the separator, based on the time that the mass analyser detects these ions.

The mass analyser may be a time of flight (TOF) mass analyser.

The mass analyser may repeatedly mass analyse the ions eluting from the IMS device (or ions derived therefrom) at a relatively high rate so as to sample the ions exiting the ion mobility separator (or ions derived therefrom) multiple times during each ion mobility peak. The mass analyser is desirably operated at a high enough sampling rate so as to obtain sufficient data points to construct a mobility peak that faithfully represents the intensity profile of ions eluting from the ion mobility separator as a function of elution time from the separator.

The method may comprise filtering the mass spectral data so as to obtain only data that corresponds to detected ions having a selected mass to charge ratio, thereby obtaining filtered data that is representative of the intensity of the ions of the selected mass to charge ratio as a function of elution time from the separator; and wherein said step of detecting the first and second ion mobility peaks comprises detecting first and second ion mobility peaks in the filtered data.

The step of filtering the mass spectral data may comprise filtering the mass spectral data so as to obtain only data that corresponds to detected ions having a mass to charge ratio equal to the mass to charge ratio of one of said dimers.

The step of filtering the mass spectral data may comprise filtering the mass spectral data so as to obtain only data that corresponds to detected ions having a mass to charge ratio equal to the mass to charge ratio of a monomer of one of said dimers.

The method may comprise selecting whether to determine the enantiomeric purity of the analyte using the data filtered according to the mass to charge ratio of the dimer, or the data filtered according to the mass to charge ratio of the monomer. For example, this selection may be made based on the determination of which of these spectral data has the highest abundance of ions. Alternatively, both sets of filtered data may be used.

The method may comprise mass filtering ions and only transmitting ions having a selected mass to charge ratio, corresponding to that of one of said dimers, to an ion mobility separator that performs said step of separating the ions by ion mobility.

The first ion mobility peak may correspond to homodimer ions and the second ion mobility peak may correspond to heterodimer ions, and the step of determining the enantiomeric purity of said analyte may comprise: using a calibration function to calculate the enantiomeric purity from the ratio of the peak area of the first ion mobility peak to the peak area of the second ion mobility peak, wherein said calibration function accounts for differences between the association energy for forming a homodimer from monomers and the association energy for forming a heterodimer from monomers.

The method may comprise the steps of: determining a calibration function from a sample with a known enantiomeric purity and using the calibration function to calculate the enantiomeric purity from the ratio of the peak area of the first ion mobility peak to the peak area of the second ion mobility peak, wherein said calibration function accounts for differences between the association energy for forming a homodimer from monomers and the association energy for forming a heterodimer from monomers.

The method may be performed on a mass spectrometer having an ion mobility separator, and wherein the spectrometer has processing circuitry configured to calculate said ratio, such as by dividing the peak area of the first ion mobility peak by the peak area of the second ion mobility peak.

In a second aspect, there is provided a mass spectrometer for determining the enantiomeric purity of an analyte comprising:
an ion source for ionising an analyte;
an ion mobility separator for separating ions by mobility; and
control circuitry configured to:
   control the ion source to ionise the analyte;
   control the ion mobility separator to separate ions of different dimers of the analyte by ion mobility and obtain mobility spectral data;
   detect a first ion mobility peak in the mobility spectral data corresponding to ions of one or more first dimers, and detect a second ion mobility peak mobility spectral data corresponding to ions of one or more second dimers; and
   determine the enantiomeric purity of said analyte from the ratio of the peak area of the first ion mobility peak to the peak area of the second ion mobility peak.

The mass spectrometer may be configured, e.g. with control circuitry, to perform any of the methods described herein.

The method may also be applicable to other oligomers, e.g. trimers. There is therefore also provided a method of determining the enantiomeric purity of an analyte, comprising:
ionising the analyte to form oligomer ions (e.g. trimer ions);
separating ions of different oligomers (e.g. trimers) of the analyte by ion mobility;
detecting at least a first ion mobility peak corresponding to ions of one or more first oligomers (e.g. trimers) and a second ion mobility peak corresponding to ions of one or more second oligomers (e.g. trimers); and
determining the enantiomeric purity of said analyte from at least the ratio of the peak area of the first ion mobility peak to the peak area of the second ion mobility peak.

The features of the aspects and/or embodiments indicated herein are usable individually and in combination in all aspects and embodiments of the invention where technically viable, unless otherwise indicated.

### BRIEF DESCRIPTION OF THE DRAWINGS

FIG. 1 shows the results of a 20-pass cyclic IMS experiment on the [M+Na]⁺ ion of racemic thalidomide and the pure R- and S-forms at 281 m/z (top: R, middle: S, bottom racemic).

FIG. 2 shows the results of a 10-pass (a) and 20-pass (b) cyclic IMS experiment of [2M+Na]⁺ dimeric racemic thalidomide at 539 m/z.

FIG. 3 shows the results of 10-pass cyclic IMS experiments on the [2M+Na]⁺ ion of racemic thalidomide and the pure R- and S-forms at 539 m/z (top: R, middle: S, bottom: racemic).

FIG. 4 shows the results of 10-pass cyclic IMS experiments on the [2M+Na]⁺ ion of racemic thalidomide and of mixtures with different ratios of R- and S-thalidomide (from top to bottom: 20:1 S:R, 4:1 R:S, 2:1 R:S, racemic).

5 shows the change of thalidomide dimer mobility peak areas with enantiomeric ratio (experimental values and calculated values for ‘ideal’ dimers and for Response-factor adjusted dimers)

FIG. 6 shows a post-mobility mass spectrum showing both a dimer ion signal and a monomer signal due to the dimer having dissociated

FIG. 7a shows an ion mobility spectrum for the post-mobility dissociated sodiated dimer ion, at 281 m/z (10 passes) (top), and the ion mobility spectrum for the dimer ion at 539 m/z (10 passes) (bottom). As can be seen, these both have the same ion mobilities (i.e. same elution times). FIG. 7b shows the IMS data for the corresponding [M+Na]⁺ monomer (281 m/z), i.e. not the dissociated dimer.

FIG. 8 shows the results of a 10-pass cyclic IMS experiment of [2M+Li]⁺ dimeric thalidomide at 523 m/z. Top: R-thalidomide; middle: S-thalidomide; bottom: racemic thalidomide.

FIG. 9a shows ion mobility spectra for the post-mobility dissociated lithiated dimer ion, filtered at 265 m/z (10 passes). Top: R-thalidomide; middle: S-thalidomide; bottom: racemic thalidomide. FIG. 9b shows the results of a 10-pass IMS experiment on the [M+Li]⁺ monomer ion of racemic thalidomide (bottom) and the pure R-(top) and S-(middle) forms at 265 m/z

FIG. 10 shows a schematic representation of the methodology for determining which enantiomer is present in an enantiomerically pure sample (scenario 1) and for determining which enantiomer is present in excess in an analyte comprising a mixture of enantiomers (scenario 2).

FIG. 11a shows the 25-pass [2M+H]⁺ cyclic ion mobility data for D/L (racemic), D- and L-tryptophan (R˜325 ΔCCS/CCS) and FIG. 11b shows the 40-pass cyclic [2M+Na]⁺ ion mobility data for racemic, R-, and S-propranolol (R˜411 ΔCCS/CCS).

FIG. 12a shows the 25-pass [2M+H]⁺ cyclic ion mobility data for various enantiomer ratios of D- and L-tryptophan, and FIG. 12b shows the 40-pass cyclic [2M+Na]⁺ ion mobility data for various enantiomer ratios of R-, and S-propranolol

FIG. 13 shows the change of tryptophan (top) and propranolol (bottom) dimer mobility peak areas with enantiomeric ratio (experimental values and calculated values for ‘ideal’ dimers and for Response-factor adjusted dimers)

FIG. 14 shows the 10-pass cyclic ion mobility date for D-, L-, and D/L (racemic) pencillamine. The dimers are disulphide-bridged covalent dimers.

### DETAILED DESCRIPTION OF THE INVENTION

The determination of enantiomeric purity in the present invention is based on the surprising finding that self-dimerisation can be used for diastereomic differentiation in ion mobility separation. Enantiomers, which have the same collisional cross-sections (CCSs) and thus interact with the non-reactive background gas of the IMS device in the same manner, cannot be differentiated in the absence of a chiral modifier or chiral gas. In achiral IMS, enantiomers cannot be separated, therefore. Even if two peaks were to be detected in the arrival time distribution for the monomeric enantiomers, this would not be due to the monomeric enantiomers being separated by ion mobility, but would rather be caused by other effects, e.g. the two peaks can correspond to protomers.

Dimerisation of a mixture of R- and S-enantiomers affords the following diastereomic pairs of enantiomers: RR, SS, RS and SR. RR and SS dimers (i.e. homodimers) will have the same CCS (since they are enantiomers with respect to each other), and RS and SR dimers (i.e. heterodimers) will have the same CCS (since they also are enantiomers with respect to each other). RR and SS dimers will have a different CCS to RS and SR dimers, however, since RR and SS are diastereomers of RS and SR. Therefore, for a mixture of R- and S-enantiomers, one can expect two ion mobility peaks for the dimer ions in ion mobility separation: one for the RR and SS dimers, and another ion mobility peak for the RS and SR dimers. For an ideal racemic mixture in which the homodimers and the heterodimers have the same association energies, one would expect the two ion mobility peaks to be of equal intensity. In practice, one type of dimer might be less stable than the other either by virtue of the mechanism of formation, e.g. during electrospray, or by their susceptibility to dissociate at various stages during transfer through the instrument (see discussion later). For an enantiopure analyte, one would expect only one peak (corresponding to RR or SS, depending on the chirality of the analyte). The difference in elution times from the ion mobility separator of the first and second ion mobility peaks is caused by the homodimer and heterodimer ions having different collisional cross sections, and hence different ion mobilities through the ion mobility separator.

The terms ‘homodimer’ or ‘homodimer ion’ herein refer to a dimer formed from the same enantiomer, i.e. RR or SS. A homodimer is therefore a dimer of two (S)-enantiomers and/or two (R)-enantiomers (SS and/or RR). Another suitable term is homochiral dimer. These can be ions I₁ in the present disclosure. The term ‘heterodimer’ or ‘heterodimer ion’ herein refer to a dimer formed from different enantiomers, i.e. RS or SR. A heterodimer is therefore a dimer of one (R)-enantiomer and one(S)-enantiomer, or one(S)-enantiomer and one (R)-enantiomer. Another suitable term is heterochiral dimer. These can be ions I₂ in the present disclosure. The homodimers and heterodimers are formed from the same monomers (the only difference being the chirality of the monomers forming them). In other words, the homodimers and heterodimers are dimers formed from enantiomers of the same analyte molecule. The homodimers and heterodimers typically have the same m/z herein. The dimers can be termed ‘self-dimers’, i.e. they are obtained by self-dimerisation.

The method described herein comprises steps of detecting ions I₁, forming a first peak in the IMS spectrum, and ions I₂, forming a second peak in the IMS spectrum. The ratio of the areas of the two peaks leads to determination of the enantiomeric purity/excess of the analyte.

Therefore, the ions causing the first peak can be termed I₁ and the ions causing the second peak can be termed 12. There is no requirement for the second peak to come after the first (the terminology is typically used herein to simply differentiate the two), but typically herein the second peak comes after the first (i.e. the elution time of the second peak is typically greater than the first peak). Ions I₂ may not be present or detected if the analyte is enantiopure (i.e. only one enantiomer). Indeed, if only one enantiomer is present in the starting analyte, then heterodimer ions would not be formed.

The ions I₁ and the ions I₂ (e.g. the homodimer ions and the heterodimer ions) preferably have the same mass to charge ratio, i.e. ‘m/z’. That m/z is typically the m/z of a dimer ion of the analyte, for example, [2M+H]⁺, [2M+Na]⁺, [2M+Li]⁺ etc. Typically, therefore, whilst ions I₁ and ions I₂ have different ion mobilities (i.e. the peaks for ions I₁ and I₂ appear at different elution times from the IMS device), the ions I₁ and I₂ have the same mass to charge ratio. The m/z is typically indicative that the ions I₁ and I₂ are dimer ions. The method may comprise a step of determining on the basis of m/z that ions I₁ and I₂ correspond to dimer ions of the analyte. Alternatively, the method can comprise a step of determining on the basis of known ion mobility data (e.g. known elution times from the IMS device), that the ions I₁ and I₂ are dimer ions (or derived from dimer ions that were separated in the IMS device). The method of the invention may comprise a step of determining, on the basis of a) m/z, and/or b) the ion mobility data (e.g. elution times), that ions I₁ and I₂ are dimer ions of said analyte.

Prior to ion mobility separation, the analyte is ionised using an ionisation device, e.g. electrospray ionisation. There is no particular limit on the nature of the ions in the method of the present invention. Typical ion adducts observed in IMS or mass spectrometry are applicable in the present method, e.g. the ions I₁ and I₂ may be [2M+H]⁺, [2M+Na]⁺, [2M+Li]⁺, [2M+K]⁺ etc.

The dimerization of the analyte can occur in solution, e.g. prior to ionisation, or during or after the ionisation process. It is the propensity of certain compounds to form dimers which enables diastereomeric differentiation.

Dimerization can occur via any chemical interaction. The dimers may be hydrogen-bonded dimers, for example. The dimers may alternatively be covalently bonded dimers, e.g. disulfide-linked dimers (these covalently bonded dimers are typically also referred to herein as adducts, e.g. [2M+H]⁺, [2M+Na]⁺, [2M+Li]⁺, [2M+K]⁺ etc). In the examples presented below and in the Figures, thalidomide was used as an analyte. The dimerization of thalidomide has been discussed in the literature (e.g. see Smith et al.: Toxicol Res (Camb). 2018 Nov. 1; 7(6): 1036-1047, or Tokunaga et al: Sci Rep 8, 17131 (2018).) Tokunaga et al. showed the hydrogen bonding of thalidomide dimers in the solid state as the following:

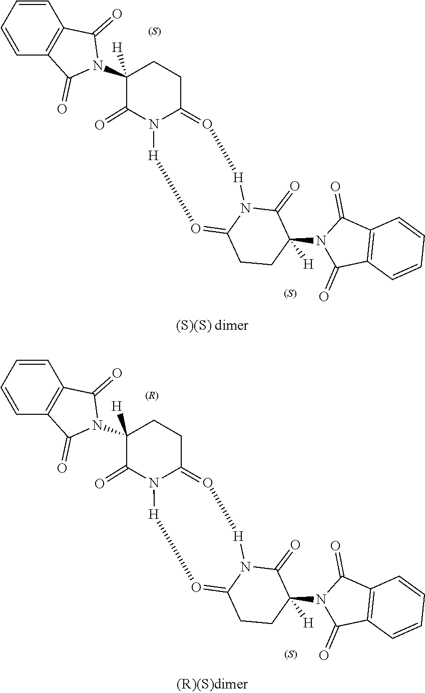

One can postulate that the dimer ions going through the ion mobility separation process in the present method have the same or similar structure. The present method is not so limited, however.

The analyte may be a chiral compound, e.g. a compound with at least one chiral centre, preferably a compound with one or two chiral centres, more preferably a compound comprising a single chiral centre. ‘Analyte’ herein can refer to a mixture of enantiomers of a compound, e.g. a mixture of R- and S-enantiomers, or an enantiopure or substantially enantiopure compound. For example, if the analyte is thalidomide, the analyte can be a mixture of R- and S-enantiomers of thalidomide. If there is more than one chiral centre in the compound, it is preferred if the analyte is a mixture of enantiomers and not a mixture of diastereomers (e.g. a mixture of SS and RR compounds, or a mixture of SR and RS compounds). The analyte can be any compound which can be analysed by ion mobility spectrometry/separation, and which is able to undergo dimerisation. The analyte may be a compound with at least one N—H and/or O—H group, and at least one ether (C—O—C) or carbonyl group (C═O), as this facilitates hydrogen bonding. The analyte may be a compound which is able to dimerise, e.g. by hydrogen bonding. The concept has been shown to work well herein with thalidomide, but it will be appreciated that the method is not only applicable to thalidomide. Indeed, the method has also been carried out with tryptophan, propranolol and penicillamine. The method is only limited by the ability of the compound to dimerise and be suitable for IMS.

The method is preferably carried out in the absence of any chiral separator, e.g. in the absence of a chiral gas in the ion mobility separator, and/or in the absence of a chiral complexing agent. The method may be carried out in the absence of any additional chiral moiety (i.e. absence of any chiral moiety except for the chiral analyte). This is a particularly beneficial aspect of the present invention: the determination of enantiomeric purity can be carried out purely on the basis of the diastereomeric differentiation of the analyte dimers. The method can be extrapolated to compounds having two or more chiral centres.

The analyte ions (i.e. ions I₁ and I₂) are separated based on ion mobility. Ions with a larger collisional cross section (CCS) will travel slower through the ion mobility separator than ions with a smaller CCS. The elution times of ions with larger CCSs are thus longer than ions with smaller CCSs.

The homodimer ions and the heterodimer ions have different CCSs, since the homodimer ions are diastereomers of the heterodimer ions. The heterodimer ions thus elute at different times to the homodimer ions. In the case of thalidomide, the CCS of the heterodimer ions is 228.9 Å², and the CCS of the homodimer ions is 226.1 Å². However, it will not always be the case that the heterodimer ions of an analyte have larger CCSs than the homodimer ions. This will depend on the specific geometry of the analyte molecule.

In the case of an ideal analyte (i.e. where the association energies for the homodimers and heterodimers are the same), when the ion mobility peaks have different integrated areas, the ion mobility peak with the larger integrated area will correspond to the homodimer ions, and the ion mobility peak with the smaller integrated area will correspond to the heterodimer ions. For example, for an enantiopure analyte, e.g. all R-enantiomers, only a homodimer (RR) peak would be detected. In a racemic mixture (i.e. 50:50 R and S enantiomers), the two ion mobility peaks will be 50:50 in area ratio for an ideal analyte where the association energies for the homodimers and heterodimers are the same (i.e. the homodimer ion mobility peak corresponding to SS and RR dimers will have the same area as the heterodimer ion mobility corresponding to RS and SR dimers). The ratio of the integrated peak area for the homodimer ions to the integrated peak area for the heterodimer ions can therefore be in the range 1:1 to 1:0. The integrated peak area of the second peak may be 0, i.e. peak not detectable (when an enantiopure or substantially enantiopure analyte is used).

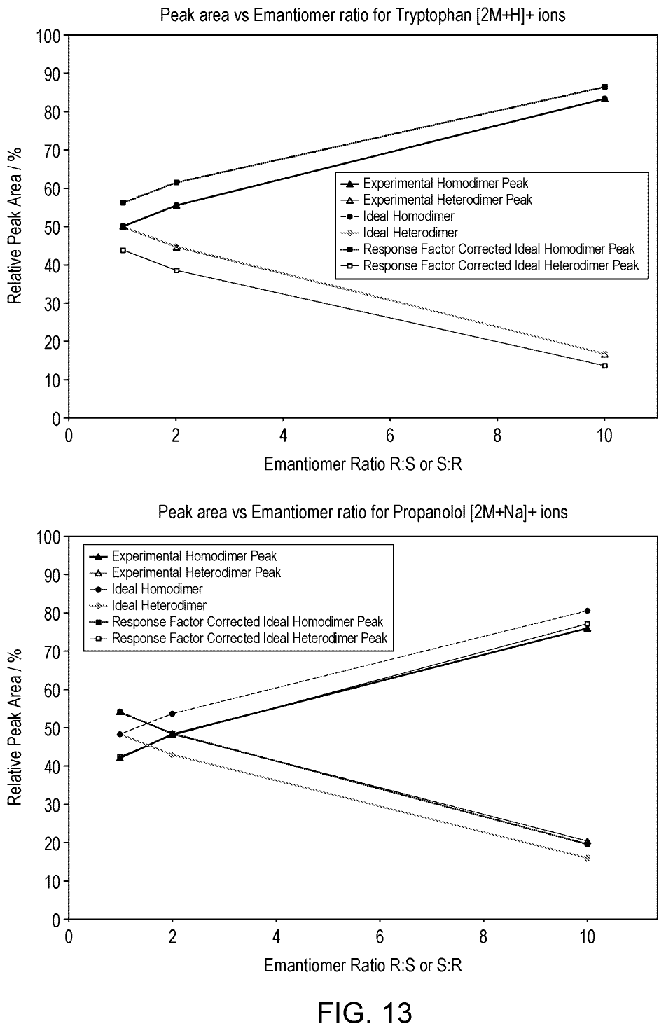

In practice, the association energies for the homodimers and heterodimers can be different. Thus, for a racemic mixture, the homodimer and heterodimer ion mobility peak areas may not have a 50:50 ratio. The ion mobility peak corresponding to the heterodimers might have a greater area than the ion mobility peak corresponding to the homodimers (as in the case of a racemic mixture of propranolol, see FIG. 13, bottom). The present inventors have found that this can be accounted for by the use of Response Factors ‘F’.

Calculation of Enantiomer Ratio from Relative Peak Areas of Homo- and Heterodimeric Species

Theoretical relative peak areas for the homodimer and heterodimer features can be calculated for the ideal case as follows

$${I}_{hom , rel} = {P}_{RR} + {P}_{SS} \qquad ( 1 )$$

$${I}_{het , rel} = {P}_{RS} + {P}_{SR} = 2 {P}_{RS} \qquad ( 2 )$$

where I_{hom,rel} and I_{het,rel} are the relative peak areas of the homodimer peak and the heterodimer peak, respectively. P_{RR}, P_{SS}, P_{RS} and P_{SR} are the probabilities of randomly forming the corresponding homodimers (RR and SS) and heterodimers (RS and SR).
P_{RR}, P_{SS}, P_{RS} and P_{SR} can be calculated as follows:

$${P}_{RR} = {( \frac{[ R ]}{[ R ] + [ S ]} )}^{2} \qquad ( 3 )$$

$${P}_{SS} = {( \frac{[ S ]}{[ R ] + [ S ]} )}^{2} \qquad ( 4 )$$

$${P}_{RS} = ( \frac{[ R ]}{[ R ] + [ S ]} ) \times ( \frac{[ S ]}{[ R ] + [ S ]} ) \qquad ( 5 )$$

$${P}_{SR} = ( \frac{[ S ]}{[ R ] + [ S ]} ) \times ( \frac{[ R ]}{[ R ] + [ S ]} ) \qquad ( 6 )$$

If it is assumed that the R enantiomer, with a relative concentration [R]ᵣₑₗ, is in excess and that the relative concentration of the S enantiomer, [S]ᵣₑₗ is 1 (e.g. in a 50:1 R:S enantiomer ratio solution [R]ᵣₑₗ=50 and [S]ᵣₑₗ=1), then substituting equations 3-6 into 1 and 2 give I_{hom,rel} and I_{het,rel} for the ideal case as:

$${I}_{hom , rel} = \frac{{[ R ]}_{rel}^{2} + 1}{{( {R}_{rel} + 1 )}^{2}} \qquad ( 7 )$$

$${I}_{het , rel} = 1 - \frac{{[ R ]}_{rel}^{2} + 1}{{( {R}_{rel} + 1 )}^{2}} \qquad ( 8 )$$

In the non-ideal case where the homodimer and heterodimer species have different association energies, the response factor can be invoked:

$${I}_{hom , adj} = \frac{{F}_{h o m} {I}_{hom , rel}}{{F}_{hom} {I}_{hom , rel} + {F}_{het} {I}_{het , rel}} \qquad ( 9 )$$

$$and$$

$${I}_{het , adj} = \frac{{F}_{het} {I}_{het , rel}}{{F}_{hom} {I}_{hom , rel} + {F}_{het} {1}_{het , rel}} \qquad ( 10 )$$

where I_{hom,adj} and I_{het,adj} are the response factor-adjusted relative intensities as a proportion of the sum of both these values (their sum will equal 1) of the homodimer and heterodimer, respectively. Fₕₒₘ and Fₕₑₜ are the response factors for the homo- and heterodimers, respectively.

In terms of [R]ᵣₑₗ as a proxy for the enantiomer ratio (E.R.):

$${I}_{hom , adj} = 1 - \frac{{2 [ R ]}_{rel} {F}_{het}}{{2 [ R ]}_{rel} {F}_{het} + {[ R ]}_{rel}^{2} + 1} \qquad ( 11 )$$

$${I}_{het , adj} = \frac{{2 [ R ]}_{rel} {F}_{het}}{{2 [ R ]}_{rel} {F}_{het} + {[ R ]}_{rel}^{2} + 1} \qquad ( 12 )$$

Equations 11 and 12 are quadratic in [R]ᵣₑₗ and so rearranging for [R]ᵣₑₗ gives two roots. The roots are [R]ᵣₑₗ and 1/[R]ᵣₑₗ meaning the non-decimal root should be taken. The non-decimal roots are obtained by either using I_{hom,obs} or I_{het,obs}, (instead of the theoretical I_{hom,adj} and I_{het,adj}) which are the observed relative peak areas of the homodimer and heterodimer measured in the experiment, respectively, and Fₕₑₜ, the heterodimer response factor. Using I_{hom,obs}:

$${[ R ]}_{rel} = \frac{- ( \sqrt{{I}_{hom , obs}^{2} {F}_{het}^{2} - {I}_{hom , obs}^{2} + 2 {I}_{hom , obs} - 1} + {I}_{hom , obs} {F}_{het} )}{{I}_{hom , obs} - 1} = E . R . \qquad ( 13 )$$

Similarly, using I_{het,obs}:

$${[ R ]}_{rel} = \frac{\sqrt{( {I}_{het , obs}^{2} - 2 {I}_{het , obs} + 1 ) {F}_{het}^{2} - {I}_{het , obs}^{2}} + ( 1 - {I}_{het , obs} ) {F}_{het}}{{l}_{het , obs}} = E . R . \qquad ( 14 )$$

As mentioned above, it is assumed in equations 7-14 that the R enantiomer is in excess. If the S enantiomer is in excess all instances of [R]ᵣₑₗ could be substituted with [S]ᵣₑₗ.

The response factor is determined empirically from experiment and is applicable to a particular chiral mixture under a given set of experimental conditions in the ion mobility mass spectrometer. In the case of an ideal mixture Fₕₒₘ and Fₕₑₜ would both be equal to 1. In non-ideal mixtures where the homodimer peak is more intense than the heterodimer peak, the major peak will have Fₕₒₘ equal to 1 and the minor peak will have Fₕₑₜ less than 1. In non-ideal mixtures where the heterodimer peak is more intense than the homodimer peak, Fₕₒₘ will be equal to 1 and Fₕₑₜ will be greater than 1. The response factor therefore acts as a numerical indicator of the deviation from the ideal mixture. As an example, in the case of thalidomide, Fₕₒₘ=1 and Fₕₑₜ=0.52. For thalidomide Fₕₒₘ and Fₕₑₜ were determined from an experiment in which the (R)- and(S)-enantiomers were mixed 1:1. The areas of each peak were integrated, the area for the larger, homodimer peak was normalised to 1, and the area of the smaller heterodimer was represented as a decimal of the homodimer peak, giving a normalised value of 0.52. For example:

$${F}_{het} = \frac{{I}_{het , obs}}{{I}_{hom , obs}} \qquad ( 15 )$$

Note that equation 15 applies only for the 1:1 (or racemic) mixture.

By determining Fₘᵢₙ or Fₕₑₜ from the experimental data a plot of [R]ᵣₑₗ vs peak areas (I_{hom,adj} and I_{het,adj}) can be constructed for a range of [R]ᵣₑₗ values. For an unknown sample I_{hom,obs} and I_{het,obs} will be measured and matched to I_{hom,adj} and I_{het,adj} values from the aforementioned plot to determine [R]ᵣₑₗ and hence the enantiomer ratio.

The method of the invention may comprise a step of using one or more of equations (1)-(15) to calculate the enantiomer ratio or purity of the analyte.

Response factors F can be calculated by, for example, determining the ratio of the peak area of the first dimer ion mobility peak to the peak area of the second dimer ion mobility peak for a known (e.g. racemic) mixture of R and S enantiomers. The response factors can then be calculated using the above equations (1)-(15).

Once Response Factors Fₕₑₜ and Fₕₒₘ are known, a single measurement of an analyte of unknown enantiomeric purity can enable the determination of the enantiomeric purity of the analyte. This can be done either via calculation using the response factors and equations 13 and 14, or via comparison to a calibration curve, as in FIG. 5, for example. The response factors Fₕₑₜ and Fₕₒₘ can account for differences between the homodimer association energy and the heterodimer association energy. The response factors can therefore enable calibration. The step of determining the enantiomeric purity of the analyte may comprise:
using a calibration function to calculate the enantiomeric purity from the ratio of the peak area of the first ion mobility peak to the peak area of the second ion mobility peak, wherein said calibration function accounts for differences between the association energy for forming a homodimer from monomers and the association energy for forming a heterodimer from monomers.

The method may comprise an initial step of determining the calibration function from a sample with a known enantiomeric purity.

The step of determining the enantiomeric purity of the analyte from the ratio of the peak area of the first ion mobility peak to the peak area of the second ion mobility peak may comprise the steps of:
a₀) optionally calculating the response factors Fₕₑₜ and Fₕₒₘ from a sample with known enantiomer concentrations;
a) determining the enantiomeric purity from the response factors Fₕₑₜ and Fₕₒₘ and the measured peak area ratio using equations (1)-(15) above;
and/or
b) comparing experimentally determined peak area ratios with a calibration curve (e.g. a calibration curve of relative peak area vs enantiomer ratio).

FIG. 5 shows the change in ion mobility peak area ratio when the ratio of the different thalidomide enantiomers are modified. The plot shows theoretical peak area vs enantiomer ratio for ideal homo- and heterodimers, the experimental peak areas vs enantiomer ratio for homo- and heterodimers, and the theoretical peak areas vs enantiomer ratio for Response Factor-corrected ideal homo- and hetero-dimer peaks. For the generation of the theoretical ‘ideal’ scenarios the contributions to the peak areas of the two features were calculated simply by the probabilities of dimer formation from the known mixing ratio of the two enantiomers (see calculations above). As can be seen from FIG. 5, the experimental data points closely match the Response Factor-corrected theoretical data points. An accurate correlation can also be seen for tryptophan and propranolol (FIG. 13).

The dimer ion mobility peak with the larger integrated area may correspond to the homodimeric ions (RR and/or SS) of the analyte, and the dimer ion mobility peak with the smaller integrated area may correspond to the heterodimeric ions (RS and/or SR) of the analyte. The reverse may also be the case, however, depending on the association energies of the homodimers and the heterodimers (reflected in the values of the Response factors F). FIG. 13 (bottom) shows the case where a racemic mixture of R- and S-propranolol gives a higher ion mobility peak area for the heterodimer.

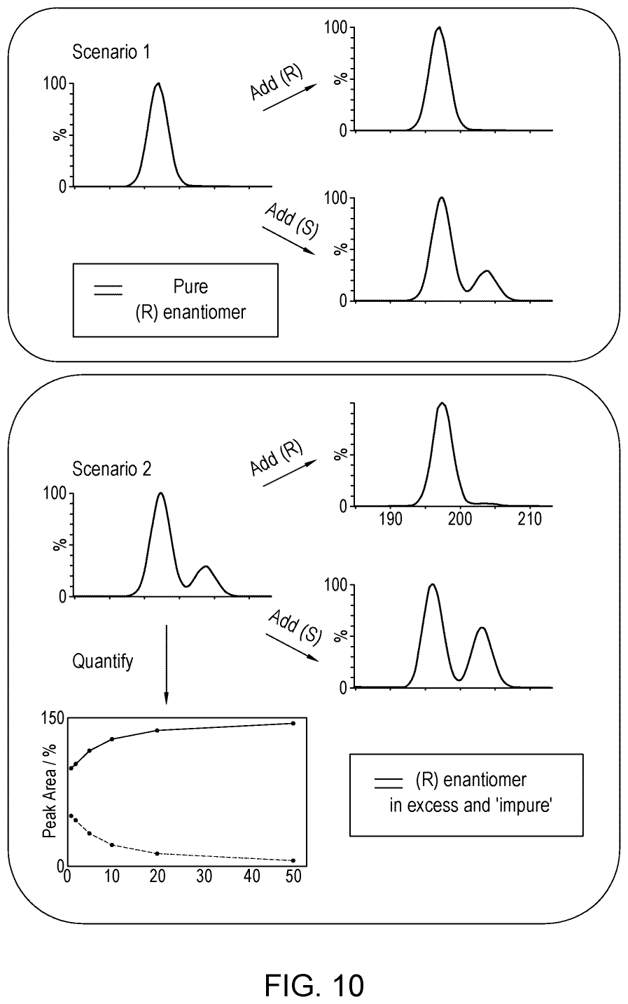

The method therefore typically comprises a step of determining that one ion mobility peak corresponds to homodimer ions of said analyte (e.g. the peak with the largest integrated area), and determining that the other ion mobility peak corresponds to heterodimer ions of said analyte. This can be done, for example, by assigning the peak obtained with an enantiopure analyte to the homodimer ions, or by spiking the mixture with a pure R- or S-enantiomer of the analyte and seeing which peak increases in relative intensity (e.g. see FIG. 10, Scenario 2). If there is only one ion mobility peak, then the analyte can be considered to be substantially enantiopure (substantially all R or substantially all S). The term ‘substantially’ is used herein since complete (i.e. 100%) enantiopurity can never, in practice, be experimentally determined.

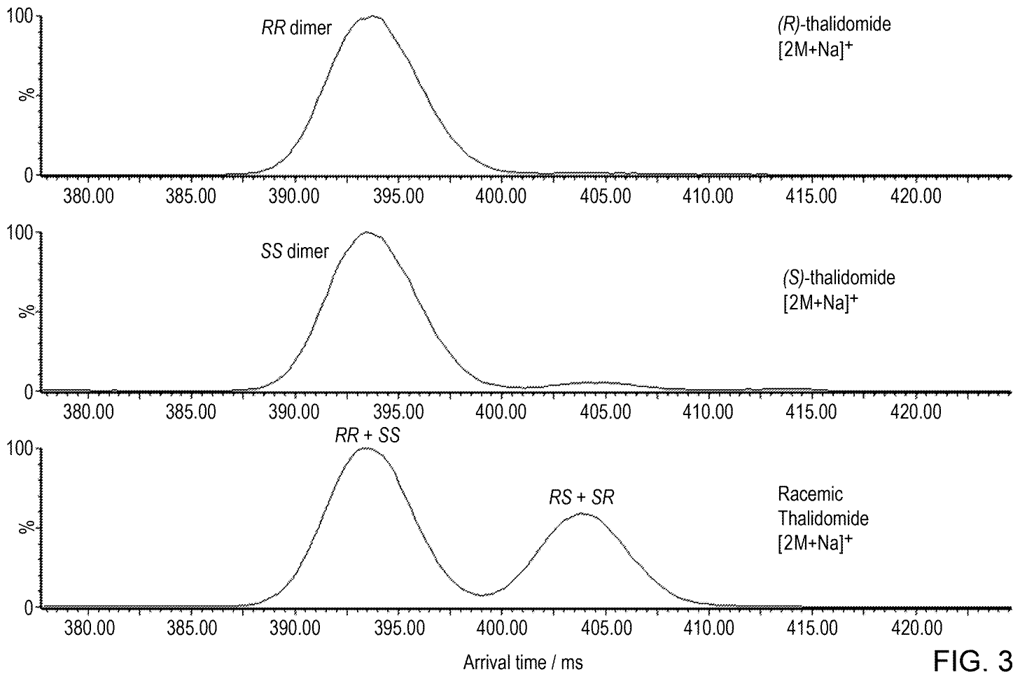

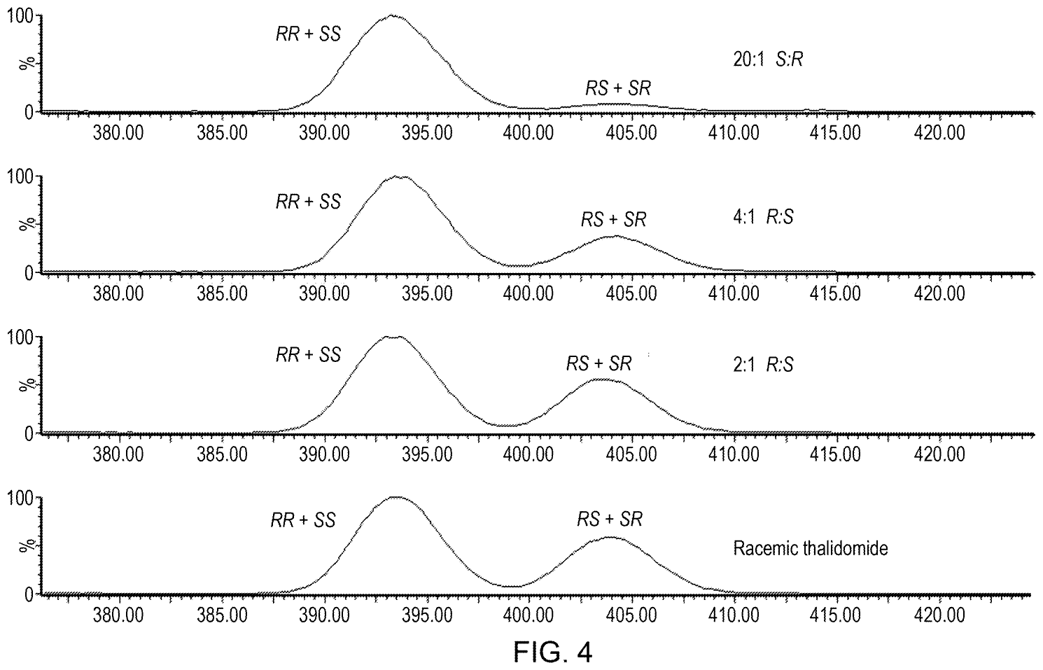

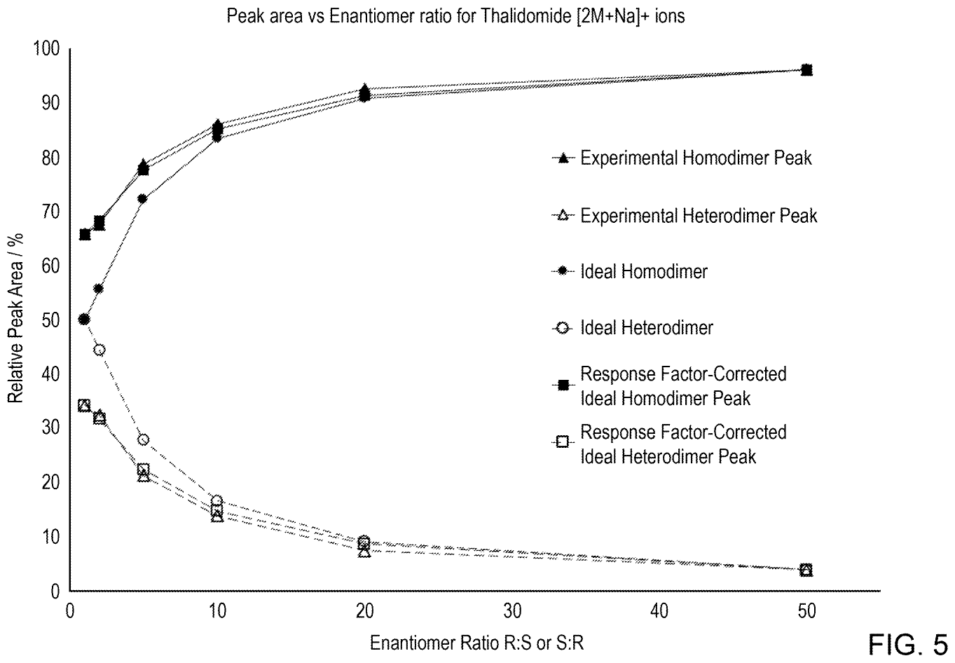

The method is particularly beneficial when it is known that one enantiomer is present in a larger amount in a starting material. The enantiomeric excess obtained by the method of the present invention then enables the determination of the proportions of specific enantiomers. However, the present method may also be used to determine which enantiomer is present in excess in a non-racemic sample (see FIG. 10). This can be done by performing a simple titration. The case of a pure enantiomer of unknown identity is considered first. The experimental homodimer ion mobility trace exhibits a single peak, as in FIG. 3, top and middle graphs. Should the user have a pure standard available of either enantiomer, two mixtures, one of the unknown with the (R) enantiomer and one with the(S) enantiomer, can be prepared. If the unknown is actually the (R) enantiomer, after mixing with the (R) enantiomer the ion mobility trace will not change. In the case of mixing with the(S) enantiomer the ion mobility trace will exhibit a second peak similar to feature 2 (i.e. right hand peak) in FIG. 3, bottom graph, or FIG. 4. This methodology is shown in FIG. 10, scenario 1. The same applies if the unknown sample is not completely pure. If more (S) is added, the intensity of the heterodimer peak will increase. If more (R) is added the intensity of the homodimer peak will increase (FIG. 10, bottom, ‘scenario 2’). Hence, the approach has another key utility-determining which enantiomer is in excess. The method may therefore comprise a step of determining which enantiomer is present in excess, by adding one or both of the pure enantiomers to the analyte, and measuring the change in relative peak intensity.

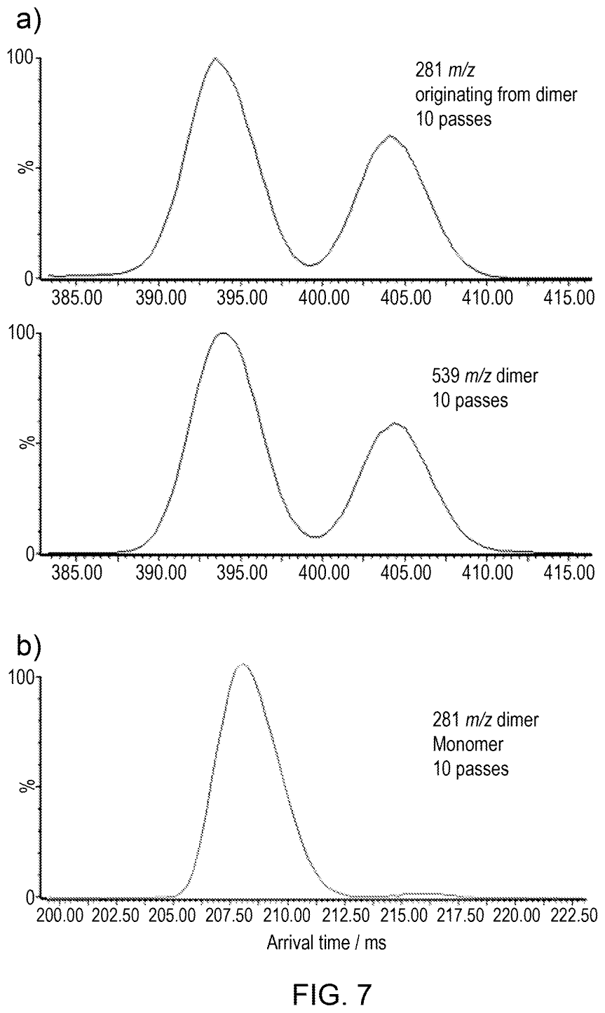

As is often the case for weakly-bonded structures, dissociation of the dimer into its component monomers can happen downstream of the ion mobility separator, e.g. before or during mass analysis. This means that the monomers that are detected can appear to have the mobility of the dimer from which they dissociated. Therefore, whilst the dimer ions going through the ion mobility separator obviously have a relatively high mass to charge ratio, the mass spectrometry data might show the presence of monomer ions (i.e. dissociated dimers) at a lower mass to charge ratio because of dissociation of the dimer. This does not affect the ability to calculate the enantiomeric purity of the sample, however, since the dissociation occurs after ion mobility separation, and thus the peak area ratios are not affected. The peaks representing monomers originating from the dissociation of the dimers will appear at the same elution times as the dimers. FIG. 7a shows that the ion mobility spectra for the dimers (bottom) and for the monomers originating from dimer dissociation (top) have the same peak area ratios. The user can filter the data to show either the monomers from the dissociated dimers (at lower m/z), or the dimers (at higher m/z). Depending on the level of dissociation of the dimers into monomers, the user could, for example, choose the data that is formed from the largest amount of ions (i.e. has the highest absolute peak intensity) and best resolution. For example, if a relatively small proportion of dimers dissociate into monomers downstream of the IMS device and before mass detection, then the dimers may be more abundant in the mass spectral data than the monomers, and so the mass spectral data obtained at the dimer m/z may be used to obtain the IMS spectrum and determine the ion mobility peak ratios. In contrast, if a relatively high proportion of dimers dissociate into monomers downstream of the IMS device and before mass detection, then the monomers will be relatively abundant in the mass spectral data, and so the mass spectral data obtained at the monomer m/z may be used to obtain the IMS spectrum and determine the ion mobility peak ratios.

Therefore, the ions detected by the mass analyser (e.g. ions I₁ and I₂) may be dimer ions or monomer ions originating from the dissociation of dimer ions of the analyte downstream of the IMS device.

The method of the present disclosure enables the determination of enantiomeric purity, i.e. the degree to which a sample contains one enantiomer in greater amounts than the other. Other suitable terms include optical purity, enantiomeric ratio etc. From enantiomeric purity (e.g. enantiomeric ratio) can be calculate enantiomeric excess, as is well known in the art.

### Ion Mobility Separation

As described above, ion mobility separation (IMS) is used to separate the monomers from the dimers, and to separate the first dimers (e.g. I₁) from the second dimers (e.g. I₂). IMS is a well-established field and any ion mobility separation instrument or method may be used in the present invention. For example, the IMS device may accumulate the ions (e.g. in an ion trap) at the upstream end of an ion separation region and then pulse the ions into a separation region. Alternatively, an ion gate or other device may be used to introduce a packet of ions into the separation region. Once introduced into the separation region, the ions may be driven through a background gas arranged therein, such that the ions separate according to their mobilities through the background gas. The ions may be driven through the background gas by a static DC potential gradient, or by repeatedly travelling a DC potential barrier along the separation region. Ions of different mobility pass through the separation region over different transit times, and therefore exit and elute from the IMS device at different times, and are detected at a downstream ion detector. The mobility of any given ion can then be determined based on the duration of time between the ions entering into the separation region (e.g. the time that ions are pulsed from the ion trap or gated into the separation region) and the time at which that ion is detected. Alternatively, the IMS device may be used simply to separate ions by mobility, rather that determining the actual mobilities of the ions.

Although ions have been described as being driven through a (static) background gas in the IMS device in order to separate them by mobility, it is alternatively contemplated that the ions may be driven against an opposing gas flow, e.g. by the DC voltage gradient or DC travelling potentials. The gas flow may be in a direction from the exit of the IMS device towards its entrance, or vice versa.

It is contemplated that the IMS device may have a linear ion guide in the ion separation region, along which the ions are driven in order to separate them according to ion mobility. Alternatively, the ion guide may take other forms, such as a closed-loop ion guide. For example, the ion guide may have a substantially circular, oval or serpentine shaped ion path. The ions may be injected into the closed-loop ion guide, then driven around the ion guide the number of times required in order to separate the dimers (and optionally to separate the monomers from the dimers) by the required ion mobility resolution, and then ejected from the ion guide. For example, the ions may be driven around the ion guide between 2-100 time, between 5-50 times, between 5-30 times, or between 10-20 times before being ejected. In embodiments where the ions guide is a closed-loop ion guide it is preferred that DC potentials are repeatedly travelled along the ion guide in order to separate the ions by mobility.

The ions that elute from the IMS device (or ions derived therefrom) may be transmitted into a mass analyser and mass analysed, e.g. by a time of flight (TOF) mass analyser. The detector of the mass analyser may be used as the detector that determines the elution times of the ions that elute from the IMS device. For example, a TOF mass analyser may repeatedly mass analyse the ions eluting from the IMS device (or ions derived therefrom) at a relatively high rate so as to sample the ions exiting the IMS device (or ions derived therefrom) multiple times during each ion mobility peak. The TOF mass analyser is desirably operated at a high enough rate so as to obtain sufficient data points to construct a mobility peak that faithfully represents the intensity profile of ions eluting from the IMS device as a function of elution time from the IMS device. The mass analyser also obtains mass spectral data representative of the mass to charge ratios of the ions that is detects. The mass spectral data is correlated to the elution times of ions from the IMS device, based on the time that the mass analyser detects the ions. As such, it is possible to filter the data that has been acquired according to m/z so as to obtain mobility data that is only for a specific m/z or range of m/z. This filtered mobility data is then representative of the intensity of the ions as a function of elution time from the IMS device.

As described above, the dimers are separated in the IMS device and are mass analysed. As such, the mass spectral data may be filtered so as to obtain only mobility data corresponding to the m/z of the dimers. This reveals two mobility peaks for the dimers, the areas of which may then be compared so as to determine the enantiomeric purity, as described above.

However, at least a proportion of the dimers may dissociate into their constituent monomers downstream of the IMS device and before being detected by the mass analyser. As such, the mass analyser will obtain mass spectral data having a mass to charge ratio corresponding to that of the monomer, but at times that correspond to the elution times of the dimers. The mass spectral data may be filtered so as to obtain only mobility data corresponding to the m/z of the monomers. This also reveals two mobility peaks (corresponding to the mobilities of the dimers), the areas of which may then be compared so as to determine the enantiomeric purity, as described above.

The mass spectrometer may be configured to select whether to determine the enantiomeric purity of the analyte using the data filtered according to the m/z of the monomers, or the data filtered according to the m/z of the dimers. For example, this selection may be made based on the determination of which of these spectral data has the highest abundance of ions. Alternatively, both sets of filtered data may be used.

In order to simplify the spectral processing required, a mass filter may be provided upstream of the IMS device. The mass filter may be operated such that only ions having a m/z corresponding to that of the dimers are transmitted to the IMS device.

The use of ion mobility separation in the present invention is important. Firstly, the propensity of analytes to dimerise during the ionisation process prior to the ion mobility separation is beneficial. Analytes tend to be concentrated during an electrospray process, for example, and the proportion of dimers in an association reaction will increase accordingly.

Secondly, the dimers can have a strong ability to stay dimerised during the ionisation and ion mobility separation processes. Given the relatively weak nature of the interactions causing dimerization (e.g. hydrogen bonding), conventional chromatographic techniques (e.g. HPLC) would typically not be suitable given, for example, the interactions with the stationary phase. If the dimers are hydrogen bonded, such bonds are stronger in the gas phase after ionisation, thus increasing the survival of associated ions. Generally speaking, the self-selection in other techniques such as NMR or HPLC is a dynamic equilibrium. For IMS, it is a kinetically trapped dimeric state present in the gas phase.

Thirdly, ion mobility separation is a particularly beneficial technique since it is quick, easy and adaptable. In particular, it is easy to change gas pressure, gas type and voltages used to separate the ions in the IMS device so as to suit the particular analyte under investigation. As mentioned previously, the ability to determine enantiomeric purity is done by diastereomeric differentiation of dimers originating from self-dimerisation.

By ‘subjecting’ an analyte to ion mobility separation is meant herein separating ions of said analyte in an ion mobility separator. The method may comprise the steps of: transmitting a plurality of ions of said analyte to an ion mobility separator; separating the ions (i.e. ions I₁ and ions I₂) according to ion mobility; detecting ions that have exited the ion mobility separator with a detector, e.g. time of flight mass analyser; recording the intensity of the ion signal output from the detector to produce recorded data, e.g. the first and second peaks herein; and determining the ion mobilities of the ions that have been detected.

The method can comprise a step of detecting ions downstream of the ion mobility separator and determining, from their times of detection, the ion mobilities of ions that were transmitted through the ion mobility separator.

In the ion mobility spectra of the present invention, the x-axis typically corresponds to elution time from the ion mobility separator and the y axis is relative signal intensity.

### Examples

### Materials

All molecules studied were purchased from Sigma-Aldrich (Gillingham, UK) as follows; (R)-thalidomide (T151), (S)-thalidomide (T150), D-penicillamine (P4875), L-penicillamine (196312), L-tryptophan (T8941), D-tryptophan (T9753), (R)-propanolol (P0689), and(S)-propanolol (P8688).

### Sample Preparation

(R)- and (S)-thalidomide solutions were prepared gravimetrically to a stock concentration of 1 mM in a solution of 50:49:1 methanol/acetonitrile/formic acid (v/v %). The stock solution was diluted to 100 μM with 50:49.9:0.1 methanol/water/formic acid (v/v %) before direct infusion into the Z-spray ion source at a flow rate of 5 μL/min. Stock solutions of D-penicillamine and L-penicillamine were prepared to a concentration of 1 mM in water and diluted to 100 μM with 50:49.9:0.1 methanol/water/formic acid (v/v %) before direct infusion. L- and D-tryptophan and (R)- and (S)-propanolol were prepared individually to stock concentrations of 1 mM in 50:49.9:0.1 water/acetonitrile/formic acid (v/v %) and diluted to 100 μM in the same solvents prior to analysis. To simulate racemic mixtures of the compounds, equal volumes of equimolar stocks of each enantiomer were mixed before ion mobility-mass spectrometry analysis. When required, stock solutions of 1 M NaCl or 1M LiCl were added to final concentrations of 1 mM to promote sodium and lithium adduct formation.

### Ion Mobility-Mass Spectrometry

All experiments were performed using a SELECT SERIES Cyclic IMS instrument (Waters Corporation, Wilmslow, UK). For high resolution multipass cyclic ion mobility analysis the travelling wave pulse height was set to 12 V, with a velocity of 375 m/s. The number of passes was varied by choosing appropriate ‘separate’ times in the instrument control software. Pre- and post-mobility voltages were minimised to preserve the dimer complexes throughout the instrument; trap and transfer collision voltages 4 and 2 V, respectively, post-trap gradient 5 V, post-trap bias 15 V, helium cell entrance 3 V, helium cell bias 22 V, array pulse height in eject 15 V, pre-transfer gradient 5 V.

For CCS measurements a travelling wave height of 15 V was used with a wave velocity of 375 m/s. The instrument was CCS-calibrated with a number of ions from the CCS Majormix calibration standard (Waters part number 186008113), using a power law of the form y=ax^{b} where a and b are constants determined by fitting a linear regression to a natural log-log plot of reduced CCS vs arrival time.

The arrival times given herein are in milliseconds (ms), unless indicated otherwise.

### Software and Data Analysis

Data were manually processed using Masslynx v4.2 (SCN 1016) with TWCCSN2 values being determined using UNIFI 1.9.4 (both Waters Corp., Wilmslow, UK). For Gaussian fitting of arrival time distributions (ATDs) Microsoft Excel was used.

### Multipass Cyclic IMS of Thalidomide—Analysis of Enantiomer (Monomer) Peaks

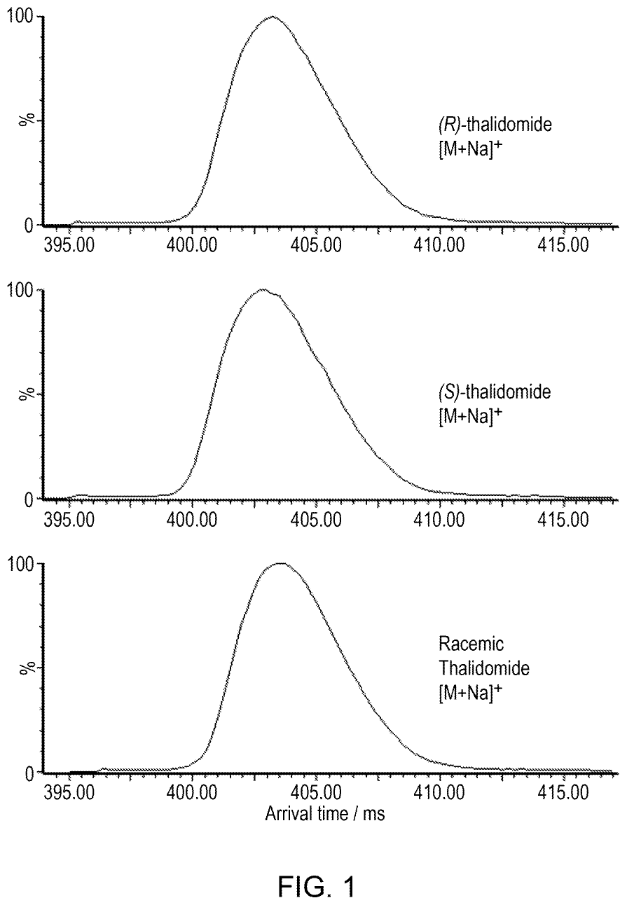

R-thalidomide, S-thalidomide, and racemic thalidomide were passed around a closed-loop IMS device (also known as a cyclic IMS device) 20 times, where the IMS device has a mobility resolution of 290 CCS/ACCS. All ions for the thalidomide (monomer) eluted from the IMS device at identical times, showing that the enantiomers cannot be separated without a chiral modifier. The ions were characterised as the [M+Na]⁺ ions at 281 m/z by TOF mass spectrometry. The CCS value for thalidomide [M+Na]⁺ was determined from the measured elution time from the IMS device as 166 Å². The results can be seen in FIG. 1.

### Multipass Cyclic IMS of Thalidomide—Analysis of Dimer Peaks

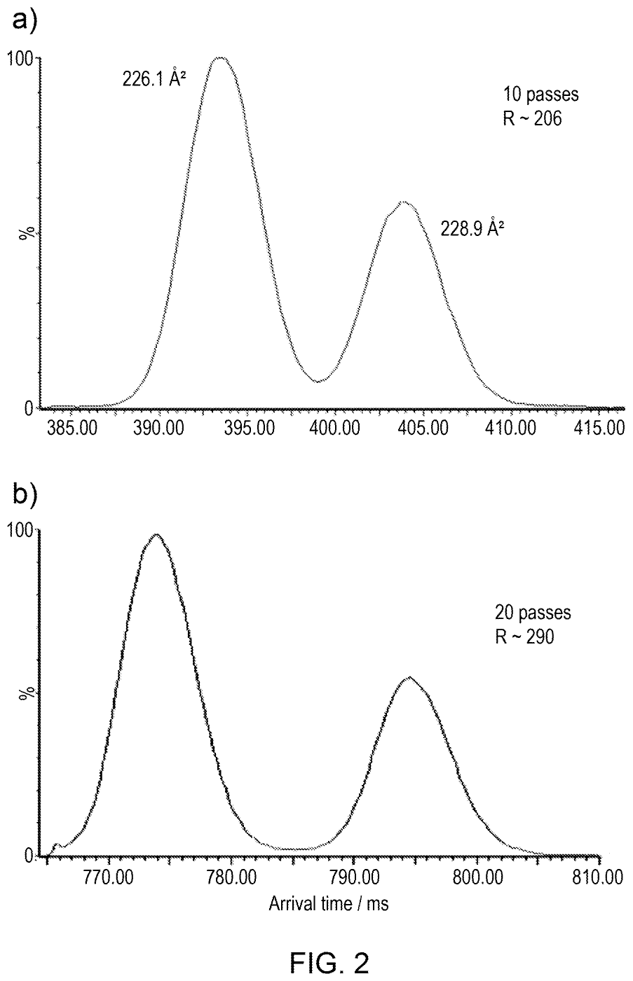

The dimer at 539 m/z (corresponding to [2M+Na]⁺) for racemic thalidomide displayed two ion mobility peaks, consistent with two pairs of diastereomeric enantiomers (RR+SS and RS+SR). The results are shown in FIGS. 2a (10 passes around the cyclic IMS device) and FIG. 2b (20 passes around the cyclic IMS device). The data is obtained by filtering the mobility-mass spectral data to 539 m/z. The CCSs of peak 1 (left peak) and peak 2 (right peak) in FIG. 2a are 226.1 and 228.9 Å². The results confirm diastereomeric separation of the dimers by ion mobility.

Multipass Cyclic IMS of Thalidomide-Determining which Peak Corresponds to the Heterodimers (RS and SR), and which Peak Corresponds to the Homodimers (SS and RR)

The 10 pass data for the racemic thalidomide dimer were compared to that of the individual enantiomers to determine which peak corresponds to the heterodimers (RS and SR), and which peak corresponds to the homodimers (SS and RR). The results are presented in FIG. 3. The dimer observed in the R-thalidomide sample appears at the same IMS elution time as that in the S-thalidomide sample, consistent with enantiomeric homodimer formation. These are at the same IMS elution time as peak 1 (left peak) in the racemic mix, showing peak 1 as being constituted by a mix of RR and SS dimers. This indicates that peak 2 (right peak) is constituted by a mix of RS and SR dimers. The data is obtained by filtering the mobility-mass spectral data to 539 m/z.

### Multipass Cyclic IMS of Thalidomide-Different R- to S-Ratios

In this experiment, different IMS runs were carried out with different R- to S-ratios of thalidomide. Results for ratios of 1:1 R:S (racemic), 2:1 R:S, 4:1 R:S, 20:1 S:R are shown in FIG. 4. Altering the ratios of R- to S- in the mixture resulted in a variation of the peak areas of only dimer peak 1, as expected. The area of peak 1 increases with increasing ratio because either RR or SS increase in abundance (depending on whether R or S is in excess of S or R, respectively).

### Dimer Mobility Peak Areas as a Function of Enantiomeric Excess

FIG. 5 shows a plot of the peak areas for the homodimers and the heterodimers at various R:S or S:R ratios. The plot shows theoretical peak area vs enantiomer ratio for ideal homo- and heterodimers, the experimental peak areas vs enantiomer ratio for homo- and heterodimers, and the theoretical peak areas vs enantiomer ratio for Response Factor-corrected ideal homo- and hetero-dimer peaks. For the generation of the theoretical ‘ideal’ scenarios the contributions to the peak areas of the two features were calculated simply by the probabilities of dimer formation from the known mixing ratio of the two enantiomers (see calculations above). As can be seen from FIG. 5, the experimental data points closely match the Response Factor-corrected theoretical data points.

By comparing the peak areas for the heterodimers and the homodimers, the enantiomeric purity can be calculated. If no second peak is detected, the analyte is (substantially) enantiopure. If there are two peaks (i.e. one for heterodimers and one for homodimers), then the enantiomeric purity can be calculated, either by using the Response Factor F, or by comparing to a calibration curve (see FIG. 5).

### Possible Dissociation of Dimers Post-Mobility

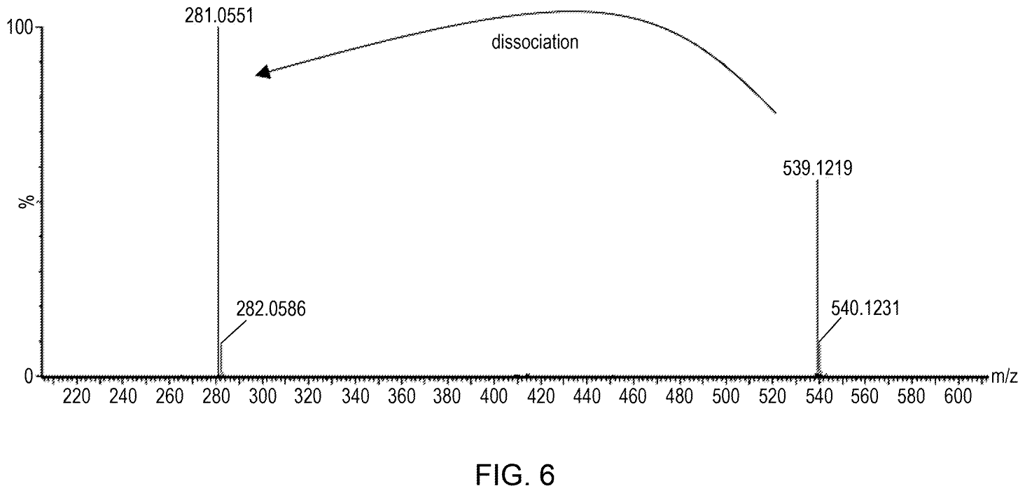

In this work it was noticed that the dimer can dissociate into monomers downstream of the mobility separator and prior to the ion detector. This means that the mass analyser may detect ions having a m/z corresponding to the monomer, but that are associated with an ion mobility corresponding to the dimer (see FIG. 7a). This could lead to misinterpretation of the data. In particular, it could be incorrectly assumed that the data shows enantiomer separation by ion mobility. An example of a mass spectrum showing dissociation of the dimer into monomers is shown in FIG. 6. However, this does not affect the ability to accurately calculate the enantiomeric purity of the analyte, since either a) complete dissociation is observed or the hetero- and homodimers dissociate at the same rate, in which case the ratios between the two peak intensities for the IMS data for the dissociated dimers is the same as that for the dimers or b) any difference in dissociation rate/ability between the hetero- and homodimers can be accounted for by the use of an appropriate response factor F. A different response factor might be used when filtering the mass spectrometry data for dimers vs monomers to glean the enantiomeric purity, therefore. The response factor must be determined from experiment. FIG. 7a shows that the ion mobility spectra for the monomers originating from the dissociation of the dimer (281 m/z, top) and the dimer (539 m/z, bottom) are identical.

The top plot in FIG. 7a shows data filtered for 281 m/z. It includes 2 mobility peaks because the homodimers and heterodimers are separated in the IMS device and so elute at different times, but the dimers then dissociate into monomers downstream of the IMS device, which is why their signal is detected at 281 m/z (i.e. the m/z of the monomer). The bottom plot in FIG. 7a shows the filtered data for 539 m/z, i.e. where the dimers do not dissociate and hence are detected at the higher m/z.

FIG. 7b confirms that the monomer which stayed as the monomer through the IMS process gave a single peak, as expected.

### Results for Lithiated Thalidomide

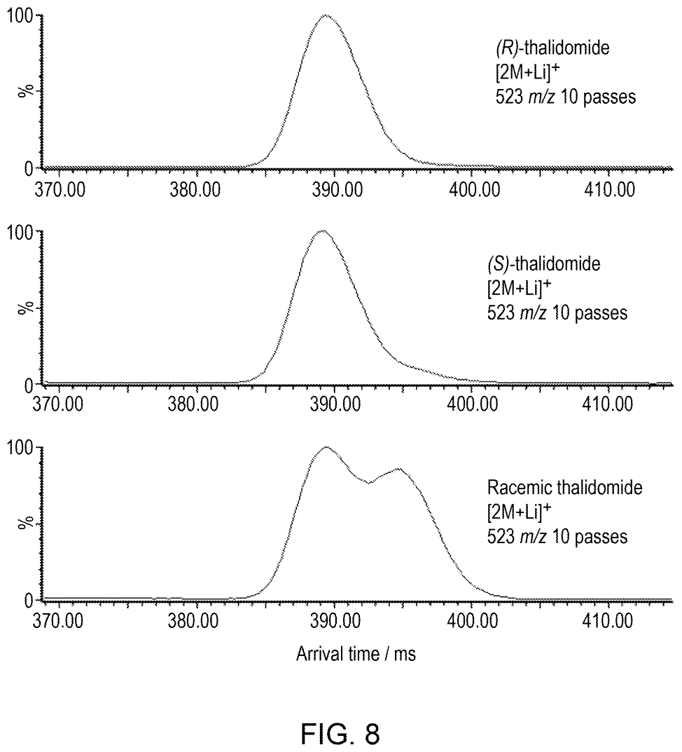

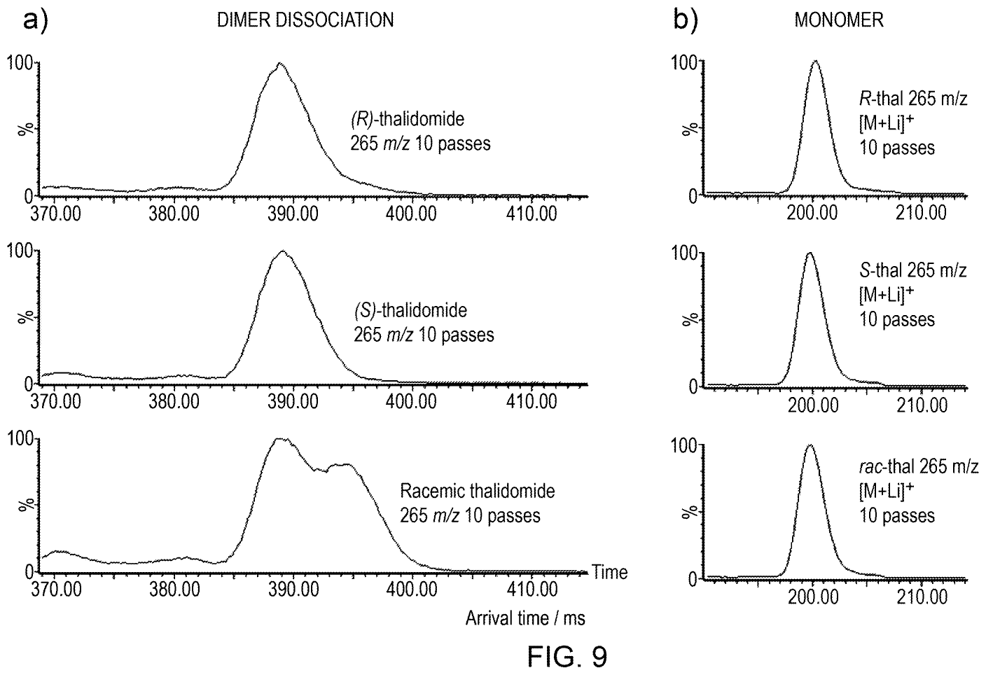

FIGS. 8-9 show that the same observations hold for lithiated thalidomide. Dimeric lithiated thalidomide (523 m/z) shows two peaks in the racemic mixture after 10 passes (FIG. 8). The corresponding monomeric signals (265 m/z) from post-mobility dissociation of the dimers also show the same two peaks (FIG. 9a). Monomeric lithiated thalidomide does not show any separation, as expected (FIG. 9b).

### Applicability to Other Chiral Systems

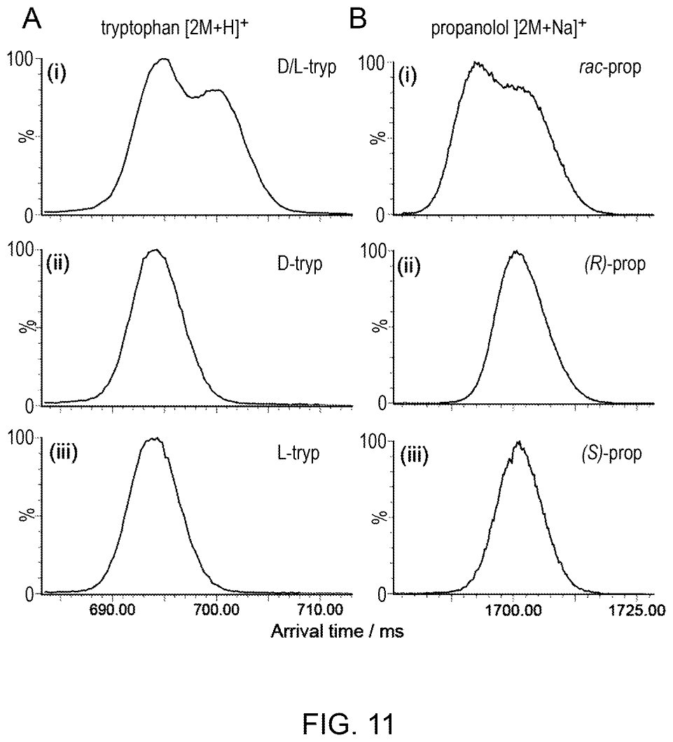

To assess the generality of the method, similar multipass cIMS experiments were performed on the chiral compounds D/L-tryptophan (tryp) [2M+H]⁺, (R)/(S)-propanolol (prop) [2M+Na]⁺, and D/L penicillamine (disulphide dimer) (see FIGS. 11-14). For D/L-tryptophan 25 cIMS passes were performed yielding a mobility resolving power of approximately 325 ACCS/CCS. The arrival time distribution (FIG. 11a (i)) exhibited two partially resolved features, suggesting the formation of homo- and heterodimers in the same way as for thalidomide. Performing the same experiments on isolated D- and L-tryp (FIG. 11 Aii and iii) yielded identical single features for the homodimers that align with the more mobile ion population (feature 1—left peak) in the D/L-tryp ATD. This indicates that this is the homodimer and feature 2 (right peak) is the heterodimer.

For rac-prop (FIG. 11B (i)), 40 cIMS passes were performed to gain partial separation of the dimer ions, corresponding to a mobility resolving power of 411 ΔCCS/CCS, a capability believe to be beyond any other commercial ion mobility system. Once more, performing the same experiment on isolated (R)- and (S)-prop (FIG. 11 B (ii) and (iii)) yielded a single feature; however, this time it aligned with the less mobile population in the rac-prop ATD indicating that in this case the homodimer ions have the greater CCS. While it is not surprising that the order of ion mobilities for dimeric ions observed using this method is not fixed, it does highlight that this method might be used to interrogate in greater detail the structures of the dimer ions alongside computational approaches.

Inspecting the ATDs for D/L-tryp and rac-prop we also notice that the relative intensities of features 1 and 2 in the ATDs of both tryptophan and propranolol in the 1:1 condition (FIG. 11 Ai and Bi) indicate that their homo- and heterodimer association energies are more similar than for thalidomide. This indicates a value of F closer to 1 for both of these systems.

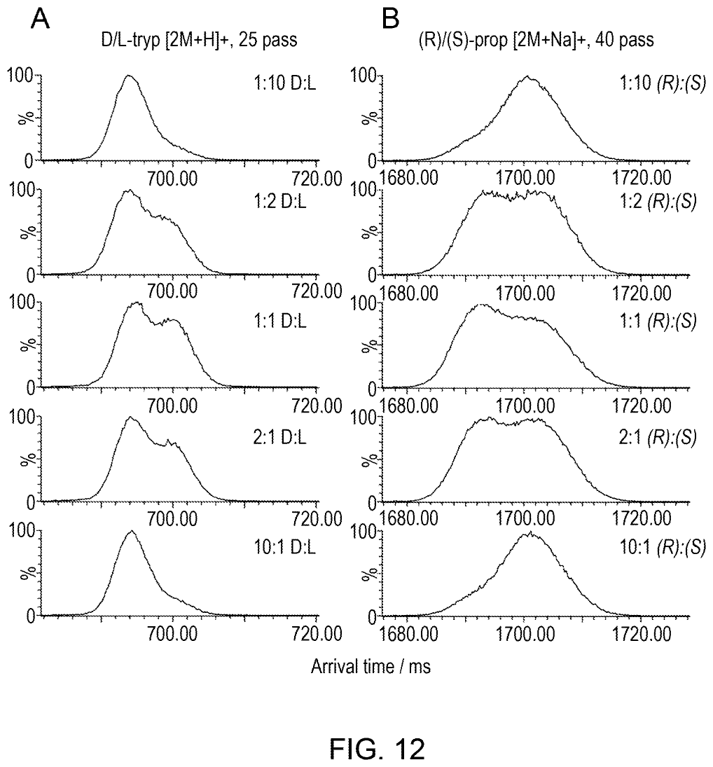

Perturbation of the ratios of the D/L-tryp and (R)/(S)-prop enantiomers revealed the dependence of enantiomer composition on the relative areas of the two features (FIG. 12), indicating that, in the same way as for thal, these ratios can be used to determine enantiomer composition given the appropriate prior information. For both tryptophan and propranolol Gaussian peak fitting was performed to determine the relative peak areas. For each, the empirical F value was determined from the 1:1 condition and applied to the other ratios and excellent agreement was observed between the corresponding ‘adjusted ideal’ curves and the experimental data (FIG. 13).

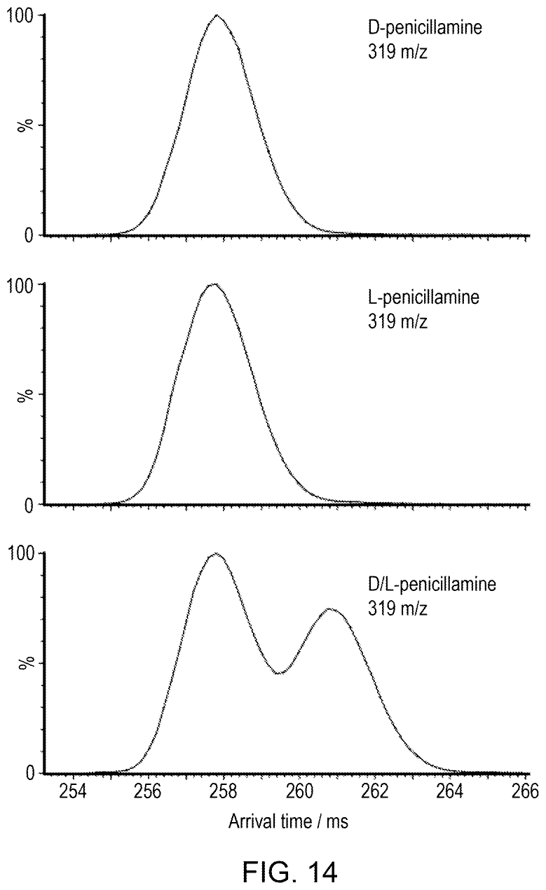

A further example of the dimerization phenomenon was found in penicillamine which, rather than forming non-covalent electrospray-mediated dimers, forms spontaneous disulphide-linked dimers. Performing a 10 pass cIMS experiment on the D/L-penicillamine mixture yielded two features, with only one in the isolated D- and L-forms (FIG. 14).

### CONCLUSIONS

We show that racemic thalidomide (e.g. [M+Na]+ or [M+Li]+) is not separated by mobility into its enantiomers using ion mobility without a chiral modifier, in line with theory.

Dimeric [2M+Na]+ (or [2M+Li]+) from racemic thalidomide exhibits two species in its ion mobility elution time distribution consistent with the formation of diastereomeric pairs of enantiomers, i.e. RR, SS and RS, SR.

Acquiring data on individual enantiomers supports this. Altering the ratio of either R or S only increases the relative intensity of one of the peaks. These dimer signals can be used to estimate enantiomeric excess on the basis of the ratio of peak areas.

Similar observations are obtained for tryptophan, propranolol, and penicillamine.

Any dimer dissociation downstream from the ion mobility separator can be accounted for, and, in some instances where there are high levels of dissociation to the monomer, can be beneficial since the m/z data for the dissociated dimer can have higher signal intensity than for the dimer.

1. A method of determining the enantiomeric purity of an analyte, comprising:
ionising the analyte to form dimer ions;
separating ions of different dimers of the analyte by ion mobility;
detecting a first ion mobility peak corresponding to ions of one or more first dimers and detecting a second ion mobility peak corresponding to ions of one or more second dimers; and
determining the enantiomeric purity of said analyte from the ratio of the peak area of the first ion mobility peak to the peak area of the second ion mobility peak.

2. The method of claim 1, wherein the first ion mobility peak corresponds to homodimer ions and the second ion mobility peak corresponds to heterodimer ions.

3. The method of claim 2, comprising determining that the peak area of the second mobility peak is equal to or less than the peak area of the first mobility peak, and consequently that the first mobility peak corresponds to the ion mobility of homodimer ions of said analyte, and the second mobility peak corresponds to heterodimer ions of said analyte.

4. The method of claim 1, wherein the first ion mobility peak corresponds to ions of at least two types of different dimers and/or the second ion mobility peak corresponds to ions of at least two types of different dimers.

5. The method of claim 1, wherein each of the dimers is formed from gas phase monomer ions that are hydrogen-bonded to each other.

6. The method of claim 1, wherein the method is carried out in the absence of a chiral selector and/or in the absence of a chiral complexing agent.

7. The method of claim 1, wherein said step of separating ions is performed by an ion mobility separator; wherein ions that elute from the separator, or ions derived therefrom, are detected and mass analysed in a mass analyser so as to obtain mass spectral data that is representative of the mass to charge ratios of the ions that are detected, and wherein the mass spectral data for ions detected at any given time is correlated to the elution time of ions from the separator, based on the time that the mass analyser detects these ions.

8. The method of claim 7, comprising filtering the mass spectral data so as to obtain only data that corresponds to detected ions having a selected mass to charge ratio, thereby obtaining filtered data that is representative of the intensity of the ions of the selected mass to charge ratio as a function of elution time from the separator; and wherein said step of detecting the first and second ion mobility peaks comprises detecting first and second ion mobility peaks in the filtered data.

9. The method of claim 8, wherein the step of filtering the mass spectral data comprises filtering the mass spectral data so as to obtain only data that corresponds to detected ions having a mass to charge ratio equal to the mass to charge ratio of one of said dimers.

10. The method of claim 8, wherein the step of filtering the mass spectral data comprises filtering the mass spectral data so as to obtain only data that corresponds to detected ions having a mass to charge ratio equal to the mass to charge ratio of a monomer of one of said dimers.

11. The method of claim 1, comprising mass filtering ions and only transmitting ions having a selected mass to charge ratio, corresponding to that of one of said dimers, to an ion mobility separator that performs said step of separating the ions by ion mobility.

12. The method of claim 1, wherein the first ion mobility peak corresponds to homodimer ions and the second ion mobility peak corresponds to heterodimer ions, and wherein the step of determining the enantiomeric purity of said analyte comprises using a calibration function to calculate the enantiomeric purity from the ratio of the peak area of the first ion mobility peak to the peak area of the second ion mobility peak, wherein said calibration function accounts for differences between the association energy for forming a homodimer from monomers and the association energy for forming a heterodimer from monomers.

13. The method as claimed in claim 12, comprising determining the calibration function from a sample with a known enantiomeric purity.

14. The method of claim 1, wherein the method is performed on a mass spectrometer having an ion mobility separator, and wherein the spectrometer has processing circuitry configured to calculate said ratio, such as by dividing the peak area of the first ion mobility peak by the peak area of the second ion mobility peak.

15. A mass spectrometer for determining the enantiomeric purity of an analyte comprising:
an ion source for ionising an analyte;
an ion mobility separator for separating ions by mobility; and
control circuitry configured to:
control the ion source to ionise the analyte;
control the ion mobility separator to separate ions of different dimers of the analyte by ion mobility and obtain mobility spectral data;
detect a first ion mobility peak in the mobility spectral data corresponding to ions of one or more first dimers, and detect a second ion mobility peak mobility spectral data corresponding to ions of one or more second dimers; and
determine the enantiomeric purity of said analyte from the ratio of the peak area of the first ion mobility peak to the peak area of the second ion mobility peak.
